(19) United States
(12) Patent Application Publication
(10) Pub. No.: US 2002/0188955 A1
(43) Pub. Date: Dec. 12, 2002

(54) Digital video recording and playback system for television

(76) Inventors: Calvin Eugene Thompson, Federal Way, WA (US); Morva Renee Thompson, Federal Way, WA (US)

Correspondence Address: LAW OFFICE OF POLLY L. OLIVER, P.O. BOX 4625, FEDERAL WAY, WA, 98063, US

(21) Appl. No.: 09/878,509

(22) Filed: Jun. 11, 2001

(51) Int. Cl. G06F 3/00; H04N 5/445; G06F 13/00; H04N 7/173

(52) U.S. Cl. 725/110; 725/109; 725/44; 725/51

(57) ABSTRACT

A system and apparatus for digitally recording and playing back videos from either an Internet website or a TV broadcast or cablecast is disclosed herein. The system comprises a set-top box, along with the necessary cables and remote control units, that connects between a television set and an Internet hook-up and allows a viewer to digitally record TV shows and/or download video from the Internet and store said video on the set-top box's hard drive for later viewing (using video encoding technology). In addition to the recording and playback capabilities, the disclosed system allows the viewer to pause, rewind, slo-mo, and instant replay live television without videotapes or VCR programming.

### FIELD OF THE INVENTION

This invention relates generally to digital video recording and playback systems and more particularly to a system and apparatus for digitally recording video from either an Internet website or a television broadcast or cablecast and playing back said video on the television monitor.

### BACKGROUND OF THE FIELD

In recent years, the Video Cassette Recorder (VCR) has become almost “standard equipment” for every household with a television set (TV). Most VCRs are capable of recording analog signals from the incoming antenna or cable and then playing back such signals on a TV monitor in the form of full-length movies, music videos, and the like. More recently, Digital Video Devices (DVDs) have been developed that can play back pre-recorded digital signals on a TV monitor. These signals, whether analog or digital, may include both video and audio signals.

Also in recent years, the personal computer has become so ubiquitous that one can now find a personal computer in almost every home and workplace. With the increasing popularity of the Internet and the World Wide Web, individuals are using their personal computers to download digital data from the Internet, over a modem or “wireless” connection, and view on the computer monitor such digital audio/visual data as movie clips and music videos. Such audio/visual data is often provided by webpage providers who may restrict the downloads to “subscribers,” users who pay a periodic or one-time fee for the privilege of accessing and downloading the data.

In the U.S. Pat. No. 6,012,086 to Lowell, there is disclosed a system for automatically recording a digital Internet event transmitted to a personal computer so that the event can be later played back on the computer monitor. Lowell's system makes use of a dialogue box provided on the computer for the user to designate the source location of the event on the Internet, the start time of the recording, and the stop time of the recording. Lowell's system, however, does not provide for downloading from any source other than the Internet.

In the U.S. Pat. No. 6,172,712 to Beard, there is disclosed a system comprising a television (TV) with hard disk so that an analog signal may be recorded, stored, and played back in the TV monitor. The audio/visual data can be played back at a rate slower, faster, or the same as the original signal. Beard's system, however, does not provide for downloading from the Internet or indeed from any source other than the TV antenna or cable.

### SUMMARY OF THE INVENTION

The present invention will be discussed primarily in terms of a “video” signal. It is to be understood that the term “video” is intended to encompass the associated audio, unless specifically stated otherwise. Also, the term “broadcast” as used is intended to encompass not only FM radio waves modulated with a video signal, but also cabled signals, satellite signals, or signals from other analog and digital video and audio sources.

In a preferred embodiment of the present invention, a system is provided for enabling a user to access an Internet-based server in a home or office environment via the Internet or other broadcast network and then either view streaming video or download and store a digital or analog signal from that server and store such signal for later playback on a conventional TV monitor. The system of the preferred embodiment comprises a set-top box for interfacing the TV to the network server, an input device in the form of a mouse for inputting instructions to the set-top box, a cable connection (for data transmission) to the signal source, and a conventional TV monitor as the display device.

The set-top box of the preferred embodiment houses the main electronic components of the system, which are necessary to manage and manipulate the data, as well as any optional electronic components, which make the overall system more flexible for the viewer. According to the viewer's specific preferences, various peripheral devices may be connected to the set-top box, and the set-top box of the preferred embodiment provides expansion slots and plug-ins for such peripheral devices.

The main electronic components of the system, housed in the set-top box, include video and audio processors, encoder/decoders, synthesizers, controllers, a modem, and a video/audio synchronizer. The box system also comprises a digital-to-analog processor, an analog-to-digital processor, a memory bank, and an interface for the three main broadcast formats of NTSC, PAL, and SECAM. The box system also comprises a TV tuner, data microprocessor, system controller, and multiplexer/demultiplexer, as well as the necessary components of power supply, transformer, cache, buffer, demodulator, ROM, and integrated circuit board.

In the preferred embodiment, the set-top box system also comprises the optional components of a DVD drive, a camera interface, a decryption interface, a 3D video card and accelerator, a computer motherboard and CPU, a remote units interface, a video camera and microphone, a Smart Card for security, a picture-in-picture interface, a game controller, a hard drive, a built-in 56K modem, and a slot for cable, DSL, or satellite modem, as well as an expandable slot for additional TV tuner and a cable and satellite TV interface.

In an alternate embodiment, the invention may be incorporated into the TV monitor, obviating the need for a separate set-top box and making an integral one-piece unit. Also in alternate embodiments, or as an option to the preferred embodiment, other conventional input devices than a mouse can be used, e.g., a keyboard, joystick, or remote control. The input device is simply used by the user to give instructions to the set-top box via the user interface, which provides the user with access to specially-marked programming content pages. Such pages typically would exhibit program schedules by date and time and may also be integrated with streaming video providing previews of coming attractions and listings of full-length movie and music downloads. Such pages may in the alternative display virtual 3D icons, such that by clicking on one of the icons, the user can obtain additional detail about the programming represented. The listings may be organized by dates, show titles, subject categories, user-defined interests, etc. With these features of the user interface, a user can, for example, download the programming information via a normal Internet connection in the morning, and then in the afternoon preview from his/her office before going home in the evening, and plan viewing activities according to the previews provided. In a slightly modified configuration this same system can be applied to the movie theater industry. Newly released movies can be downloaded or streamed directly to the theaters into set-top boxes, which connect to projectors rather than televisions. Thus the theater will not have many of the hassles associated with film, such as rewinding or waiting for film to be delivered, etc.

Depending on the user's modem type and connection speed to the Internet, the system of the present invention will be capable of streaming audio and video (e.g., true video and audio on-demand in real time). The system of the preferred embodiment comprises an expansion slot so that the modem is interchangeable, depending on the user data stream connection and preference including telephone modems, cable modems, and satellite modems, in order to determine the most efficient delivery of different types of data through all of the available bandwidth connections. The system can display an Internet gateway interface (e.g., Microsoft Internet Explorer, Netscape Communicator Browsers, Real Network Real Player, and Microsoft Movie Player) so the user can surf the Internet and view web pages. This system also incorporates an interface for smart updates (Software, Programming, etc.) via the Internet. A picture-in-picture interface may also be incorporated so the user may surf the Web, receive videophone calls, play games, and watch television simultaneously.

The system of the preferred embodiment of the present invention is programmed to automatically access a network (conventional TV broadcast, cablecast, satellite TV broadcast, or the Internet broadcast) at a first specified time, download data from the server and/or receive a signal from the network directed to a specified destination device or file, stop the download at a second specified time, and automatically disconnect from the network. The system is further programmed to execute additional command sequences required to access the data, and execute diagnostic routines in case of transmission error; additionally, with its built-in smart download feature, the system will automatically resume downloading from where the transmission error occurred.

In record mode, an arrival timestamp is generated for each Internet input transport packet to be recorded on the storage device. A given arrival timestamp indicates the arrival time of the corresponding transport packet in the recording system. Each of the transport packets is then stored with its corresponding arrival timestamp. The record mode will utilize a packet identifier decoder (PID) to perform packet filtering such that only incoming transport packets with selected PIDs are stored. In playback mode, transport packets and corresponding arrival timestamps are retrieved from the storage device and the arrival timestamps are utilized to direct synchronous delivery of the transport packets to a decoder in the system. The playback mode will detect any timestamp discontinuity code in one or more of the arrival timestamps and adjust the playback system time clock accordingly when downloaded from the network database. The playback mode may also provide null packet interleaving in which a selectable number of null packets is inserted between each valid transport packet to thereby provide a selectable fixed-rate transport packet output depending on modem speed. The video/audio data stored by the system may be saved on a hard drive or other mass storage device for a predetermined period of time, after which the contents of the hard drive may be deleted or flushed from memory.

When the system is in record mode, a video signal is fed across the transmission connection to a video filter/separator, where the synchronization of the signal is to take place. The X and Z signals are separated and are respectively demodulated by a decoder and digitized by an A/D (Analog-to-Digital) converter. The video signal is preferably converted to a conventional data file format before it is applied to a video signal processor. The video signal processor comprises processing circuitry for compressing the digital video signals and memory for storing the converted video information. The A/D converter can be bypassed when a video signal is already in a digital-compatible form as received (Internet or digital broadcast); also the D/A converter can be bypassed when the system is used on a digital monitor or digital TV.

### DESCRIPTION OF THE DRAWINGS

FIG. 1 is a schematic view of the TV system of the preferred embodiment comprising two input signal sources (one digital Internet and one conventional analog), a set-top box, and a TV monitor;

FIG. 2 is a top level flow chart of the operation of the preferred embodiment of the system of the present invention;

FIG. 3 is an illustration of the Internet data packet stream;

FIG. 4 is a flow chart of the flow of the Internet data packet stream;

FIG. 5 is a component flow chart of the signal processing of the preferred embodiment of the system of the present invention;

FIG. 6 is a layout view of the preferred embodiment of the set-top box;

FIG. 7 is a back view of the preferred embodiment of the set-top box; and

FIG. 8 is a top view of a remote control unit to be used with the preferred embodiment.

### DETAILED DESCRIPTION OF THE PREFERRED EMBODIMENT

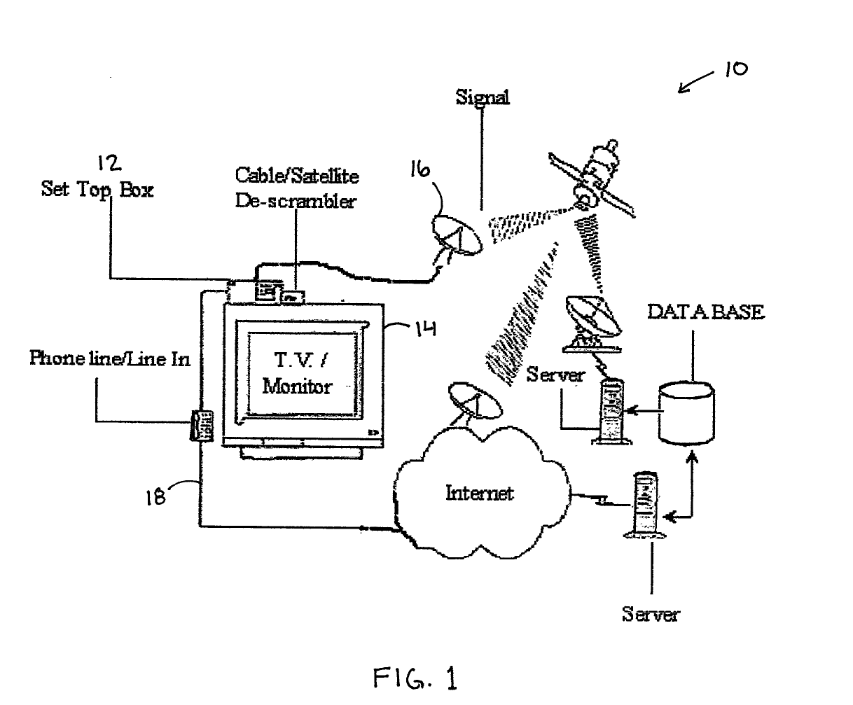

FIG. 1 illustrates how a set-top box 12 is the central element in a digital video and playback system 10. Connected to the set-top box 12 is a conventional TV set 14 with conventional monitor. Leading to the set-top box 12 are two input paths: one is an antenna cable terminating in a satellite dish 16 which will receive broadcast and cablecast digital and analog signals and transmit them to the set-top box 12; one is a telephone line modem 18 which will receive Internet digital signals and transmit them to the set-top box 12.

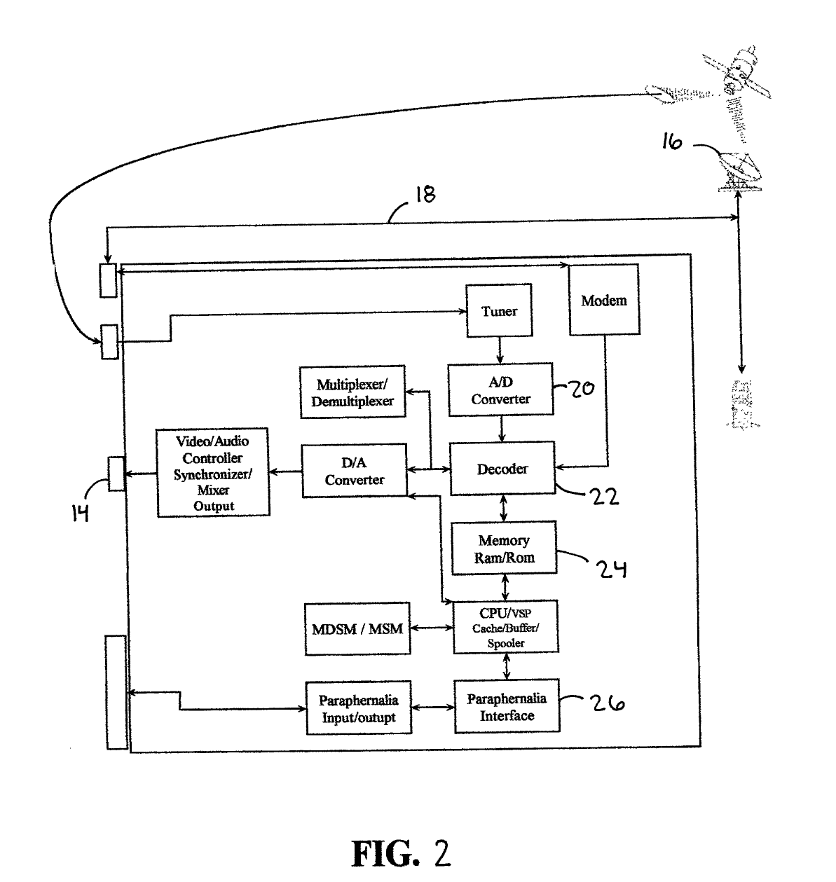

FIG. 2 shows the treatment of the data signals after they have been input into the set-top box 12. Whether the signal enters the system 10 through the satellite dish 16 or the Internet modem 18, and whether the signal enters as a digital signal or an analog signal (in which case it must be routed through the analog-to-digital converter 20), the signal will be routed through a decoder 22 for any necessary manipulation and then sent either immediately to the TV monitor 14 for viewing (e.g., streaming video/audio) or into the memory module 24 for storing for later viewing. In the preferred embodiment, the system 10 is provided with an external keyboard and printer (not shown). In this case, the data may be retrieved from the memory module 24 and accessed by the external paraphernalia by way of the paraphernalia interface 26.

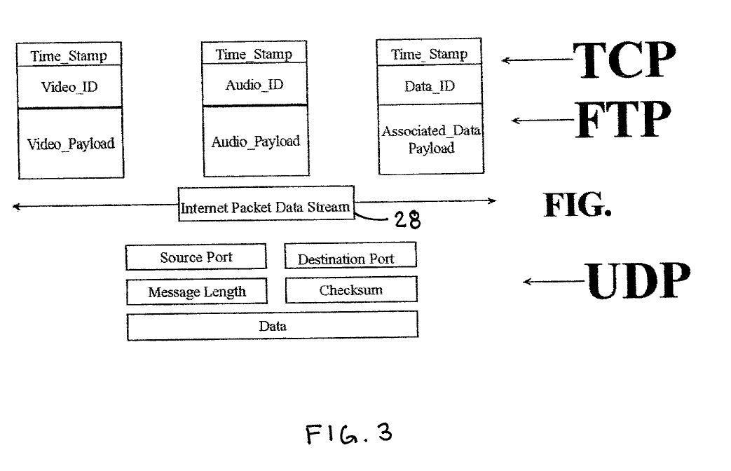

The preferred embodiment of the system 10 will have the necessary software so that the components of the set-top box 12 can handle the manipulation and storage of data being sent under any one of the conventional protocols. FIG. 3 illustrates how the configuration of the transport stream data packets 28 is different for the TCP, FTP, and UDP protocols. The TCP method is primarily a download-and-play technology. The FTP method is similar. With both methods, the entire file, both video and audio portions, must first be downloaded before it can be played back. The UDP method is the preferred method for video streaming. Alternatively, the system may be configured to handle the alternate streaming protocols of RSVP, RTP, RTCP, and/or RTSP.

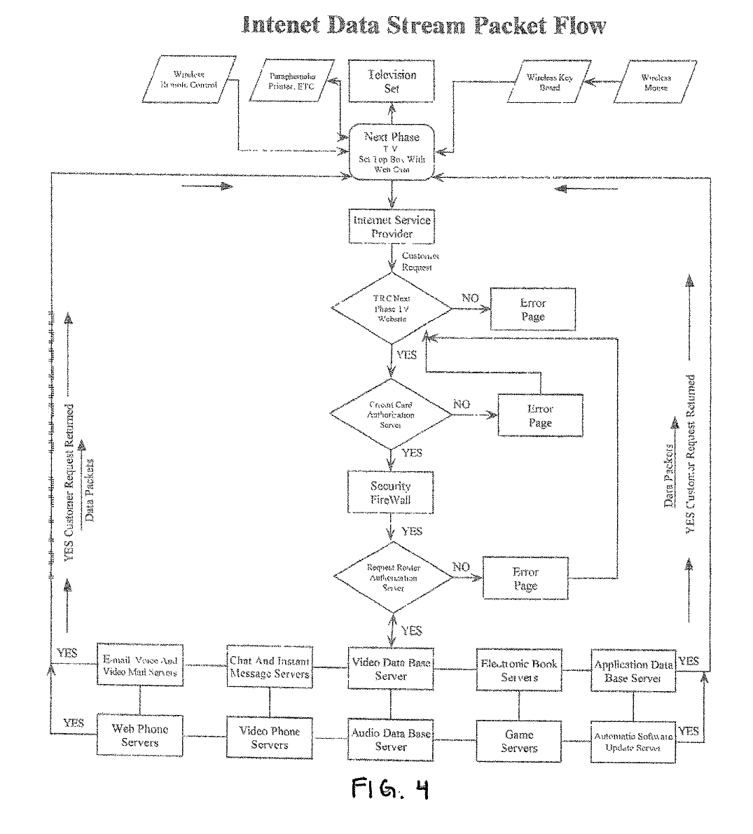

FIG. 4 shows more detail of how the data stream packets 28 are dealt with by the components of the set-top box 12. In the preferred embodiment, the system 10 is set up such that the user can obtain data from the internet or cable TV from a prepaid service provider or on a pay-per-view basis (e.g., via credit card). Such pay-per-view arrangements interject the issue of consumer privacy; therefore, the preferred embodiment also makes use of security firewall technology. Furthermore, in the preferred embodiment, the Internet modem input 18 in conjunction with conventional laptop software and hardware allows the user several enhanced options, including sending and receiving e-mail over the system 10, as well as chatting and playing games.

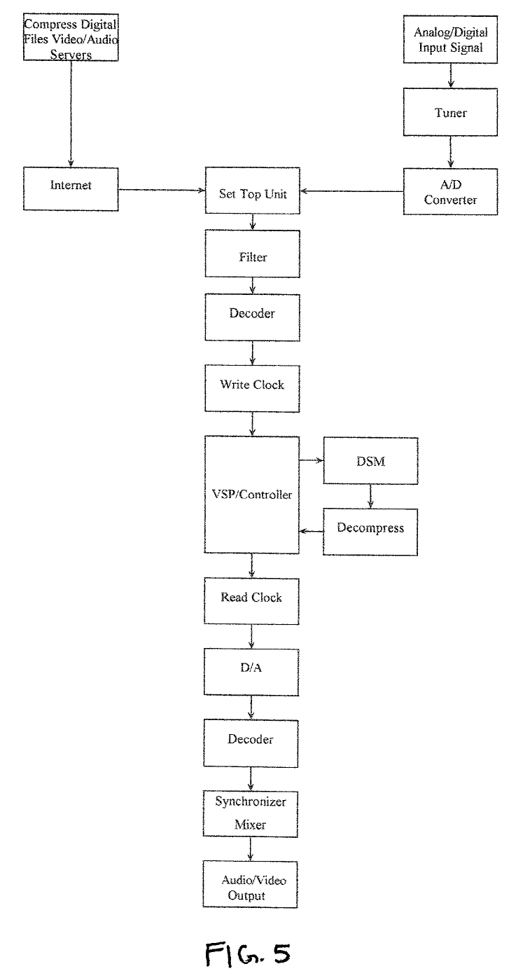

FIG. 5 illustrates generally the signal processing of the system 10 for the case of streaming video/audio. Regardless of the input path, once the signal enters the set-top box 12, it is routed generally through the same component path until it is ultimately displayed on the TV monitor 14.

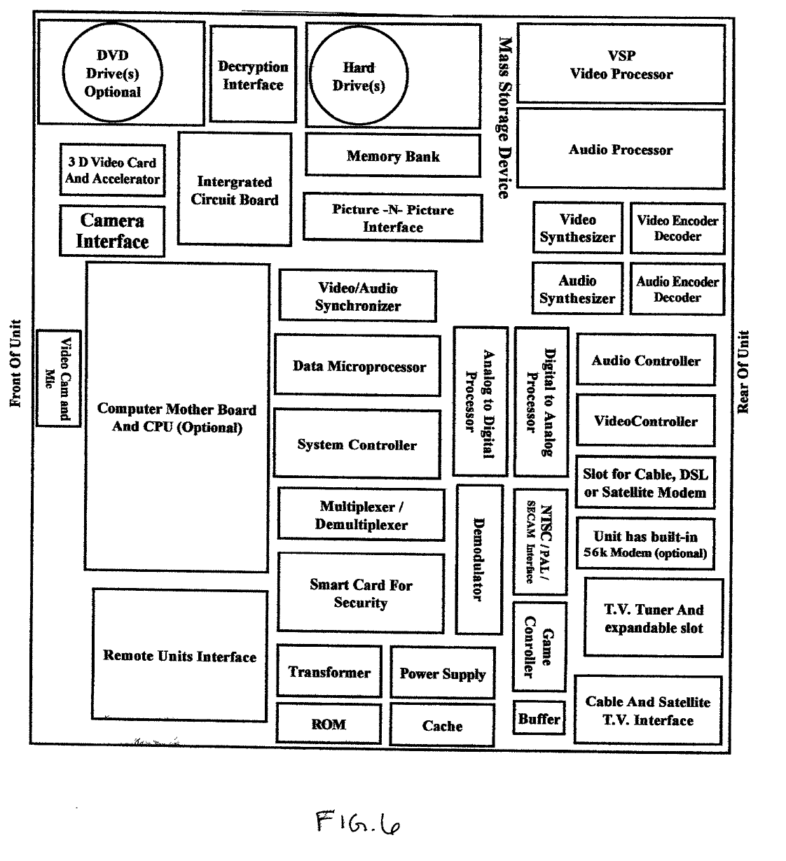

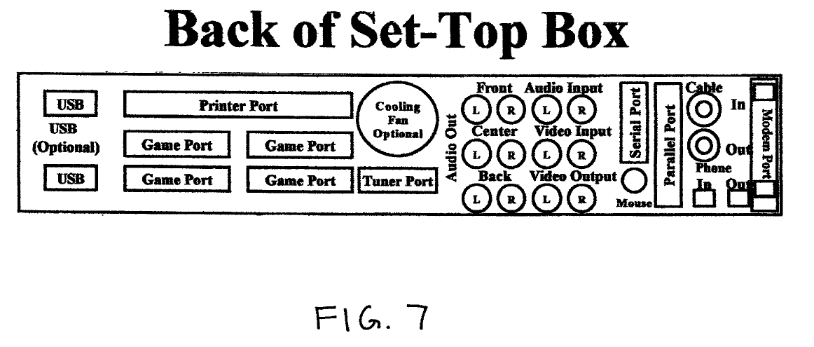

FIG. 6 illustrates the preferred layout of the components of the set-top box 12. The preferred embodiment includes several optional components so as to provide the user with enhanced capabilities of the system 10. FIG. 7 shows the back panel of the set-top box 10. It has been chosen for the preferred embodiment to configure the set-top box 10 so that the connection ports are on the back panel of the box, like with a conventional VCR or stereo component. However, the set-top box 12 will work just as well with the ports on another panel of the set-top box 12, and such a configuration may even be recommended with a different choice of component options or application scenarios.

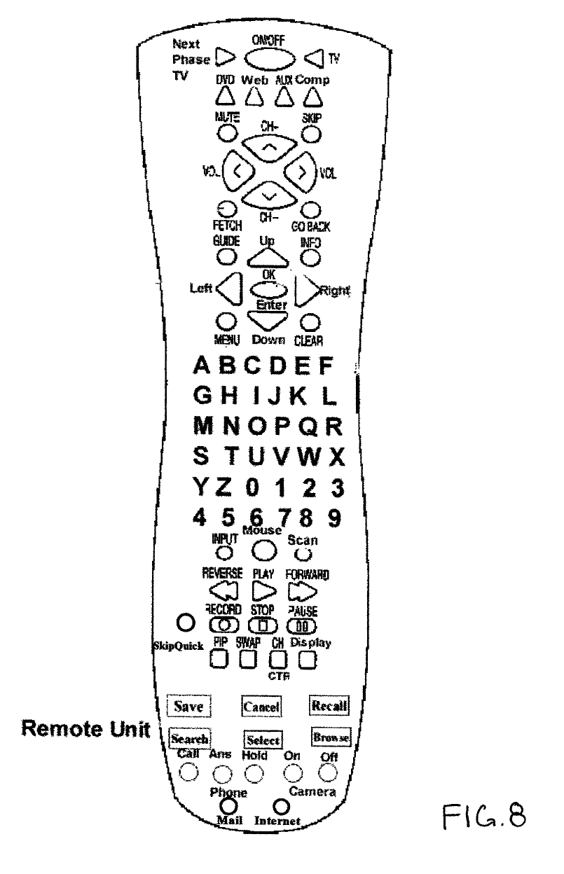

FIG. 8 has been included simply to illustrate the preferred arrangement of input keys on a handheld remote input device similar to a conventional TV remote control unit.

The description above should not be construed as limiting the scope of the invention, but as merely providing illustrations to some of the presently preferred embodiments of this invention (e.g., circuitry which enhances the separation of the signal and components, a fixed modem instead of an interchangeable modem, omitting the network card, web cam, or expandable slots, or making all circuitry fixed or integrated). In light of the above description and examples, various other modifications and variations will now become apparent to those skilled in the art, without departing from the spirit and scope of the present invention as defined in the claims. Accordingly, the scope of the invention should be determined solely by the appended claims and their legal equivalents.

What is claimed is:

1. A method for automatically retrieving electronic data transmitted over a transmission connection in communication with a data source, manipulating said electronic data according to data type, and then displaying said data on a television monitor by a viewer, the method comprising the steps of:
selecting the electronic data to be retrieved by inputting necessary instructional parameters to a user interface, using a conventional input device, in order to identify the source containing the data to be retrieved and to specifically describe the data to be retrieved;
retrieving the electronic data from the data source, such data being transmitted over the transmission connection to a set-top box in communication with the television monitor;
manipulating said electronic data within the set-top box according to data type and viewer preferences; and
displaying the data on the television monitor at a time specified by the viewer.

2. The method of claim 1 wherein the data includes both video and audio data.

3. The method of claim 1 wherein the input device is selected from the group of conventional devices consisting of keyboards, remote controls, joysticks, and mouses.

4. The method of claim 1 wherein the transmission connection is selected from the group of transmission connections consisting of cable, wireless, and infra-red connections.

5. The method of claim 1 wherein the data source is selected from the group of data sources consisting of Internet servers, conventional TV broadcasts, TV cablecasts, and satellite broadcasts.

6. The method of claim 1 wherein the set-top box comprises audio and video processors, encoder/decoders, synthesizers, controllers, synchronizers.

7. The method of claim 1 wherein the set-top box further comprises analog-to-digital converters, digital-to-analog converters, a memory bank, and data format interfaces.

8. The method of claim 1 wherein the data type is a type selected from the group of data types consisting of digital data and analog data.

9. The method of claim 1 wherein the set-top box further comprises an electronic data storage medium and the method further comprises the steps of, after retrieving the digital data from the data source, storing said data on the electronic storage medium and then retrieving at a later date said data from the electronic storage medium before manipulating said data within the set-top box and displaying the data on the television monitor at a time specified by the viewer.

10. A method for automatically retrieving into a set-top box, such set-top box comprising electronic data signal processors, digital data transmitted over a transmission connection in communication with an Internet source server, manipulating said digital data within said set-top box according to viewer preferences, converting said digital data to analog data, and then displaying said analog data on a conventional television monitor by a viewer, the method comprising the steps of:
selecting the digital data to be retrieved by inputting necessary instructional parameters to a user interface, using a conventional input device, in order to identify the Internet source server containing the digital data to be retrieved and to specifically describe the digital data to be retrieved;
retrieving the digital data from the Internet source server, such digital data being transmitted over the transmission connection to the set-top box in communication with the conventional television monitor;
manipulating said digital data through a digital-to-analog converter within the set-top box according to viewer preferences; and
displaying the analog data on the television monitor at a time specified by the viewer.

11. The method of claim 10 wherein the set-top box further comprises an electronic data storage medium and the method further comprises the steps of, after retrieving the digital data from the Internet source server, storing said digital data on the electronic storage medium and then retrieving at a later date said digital data from the electronic storage medium before manipulating said digital data through the digital-to-analog converter and displaying the analog data on the television monitor at a time specified by the viewer.

12. The method of claim 10 wherein the conventional input device is a conventional mouse.

13. The method of claim 12 wherein the transmission connection is a conventional telephone modem line.

14. An apparatus for automatically receiving electronic data transmitted over a transmission connection from a source server and manipulating said electronic data for display on a conventional television monitor, comprising:
a generally rectangular housing defined by six generally planar sides, one side being referred to as the front panel and the opposite panel being referred to as the back panel;
a video processor and an audio processor, such processors being located within the housing such that said video processor and said audio processor are in connection with external ports on the back panel of the housing;
a video encoder/decoder and an audio encoder/decoder located within the housing in proximity to and in communication with the respective video and audio processors;
a video signal synthesizer and an audio signal synthesizer located within the housing in proximity to and in communication with the respective video and audio encoder/decoders;
a video controller and an audio controller, such controllers being located within the housing such that said video controller and said audio controller are in proximity to and in communication with the respective video and audio synthesizers;
a video/audio synchronizer located within the housing in proximity to and in communication with the video and audio controllers;
a data microprocessor located within the housing in communication with said processors, said encoder/decoders, said synthesizers, said controllers, and said synchronizer;
a system controller located within the housing in communication with the data microprocessor;
a data multiplexer/demultiplexer located within the housing and in communication with the system controller;
a transmission connection in communication between the video/audio synchronizer and an output display device;
a digital-to-analog processor and an analog-to-digital processor located within the housing in proximity to and in communication with the video and audio processors and the video and audio controllers; and
a digital data storage medium located within the housing and in communication with the data processors.

15. The apparatus of claim 14 further comprising a video camera and video camera interface located within the housing such that said video camera is directed generally outward from the front panel of the housing and said video camera interface is in connection with an external port on the back panel of the housing and said video camera interface is in communication with the data microprocessor.

16. The apparatus of claim 15 further comprising a 3D video card located within the housing and in communication with the data microprocessor; and
a picture-in-picture interface located within the housing in communication with the data microprocessor.

17. The apparatus of claim 16 further comprising a decryption interface located within the housing and in communication with the data microprocessor;
a remote units interface located within the housing and in communication with the data microprocessor; and
a security Smart Card located within the housing and in communication with the data microprocessor.

18. The apparatus of claim 17 further comprising a computer motherboard and central processing unit located within the housing and in communication with the data microprocessor.

19. The apparatus of claim 18 further comprising a plurality of external ports located on the back panel of the housing.

20. The apparatus of claim 19 wherein the external ports are selected from the group of external ports consisting of serial ports, parallel ports, USB ports, printer ports, modem ports, tuner ports, and game ports.
